(19) United States
(12) Patent Application Publication
(10) Pub. No.: US 2026/0184109 A1
(43) Pub. Date: Jul. 2, 2026

(54) Aircraft Tire Carcass Reinforcements

(71) Applicant: COMPAGNIE GENERALE DES ETABLISSEMENTS MICHELIN, Clermont-Ferrand (FR)

(72) Inventors: Marc ROMERO DE LA OSA, Clermont-Ferrand Cedex 9 (FR); Nizar DIDANE, Clermont-Ferrand Cedex 9 (FR); Thierry DEUX, Clermont-Ferrand Cedex 9 (FR); Julie GOURDIN, Clermont-Ferrand Cedex 9 (FR)

(21) Appl. No.: 18/707,424

(22) PCT Filed: Oct. 25, 2022
(86) PCT No.: PCT/FR2022/052023

§ 371 Date: May 3, 2024

(30) Foreign Application Priority Data
Nov. 4, 2021 (FR) FR2111703

(51) Int. Cl. B60C 9/00; D07B 1/02

(52) U.S. Cl. CPC B60C 9/0042; B60C 2009/0085; B60C 2009/0092; B60C 2200/02

(57) ABSTRACT

An aircraft radial tire having a radial carcass reinforcement with a plurality of carcass layers made up of textile reinforcing elements oriented substantially radially, which is to say forming an angle of between 75° and 105° with the circumferential direction, the radial reinforcing elements of the carcass layers are composite cords having at least one aromatic polyamide filament yarn and of which the force at break is FR, measured in accordance with the standard D885/D885M-10A (2014), and these elements exhibit a deformation at least equal to 4.6% for an applied force equal to FR/4. The tenacity of these reinforcing elements is at least equal to 80 daN/mm², and the linear density of the one or more aromatic polyamide filament yarns does not exceed 210 tex. The thicknesses, adjusted for the shaping radii of the carcass layers, remain constant over the entire tire.

The present invention relates to an aircraft tire with radial carcass reinforcement. Such tires are intended to bear heavy loads and to be inflated to relatively high pressures in excess of 10 bar.

An aircraft tire according to the invention has a tread, a crown reinforcement and a radial carcass reinforcement, this radial carcass reinforcement having carcass layers comprising a plurality of textile reinforcing elements oriented substantially radially (which is to say making an angle of between 750 and 1050 with the circumferential direction).

The carcass reinforcement is anchored in each bead to at least one circumferential reinforcement, and usually to just one circumferential reinforcement known as a bead wire. The reinforcing elements of said carcass layers are wound around said bead wire from the inside to the outside or vice versa, forming turn-ups, the respective ends of which are spaced apart radially from the axis of rotation of the tire.

The layers of reinforcing elements or cords, whether composite or not composite, that are described above are obtained by coating these cords in a rubber compound referred to as skim compound, the number of cords per centimetre of ply, measured perpendicularly to the direction of said cords, being calculated in order to obtain the necessary tensile strength.

Solutions using composite cords or hybrid cords have notably been set out in patent EP1381525, particularly composite cords formed of at least two filament yarns of high elastic modulus and just one filament yarn of low elastic modulus, more specifically of two filament yarns made of aromatic polyamide or aramid, and one filament yarn made of aliphatic polyamide (more specifically nylon).

The filament yarns are made up of filaments. It will be recalled that, as is well known, a filament made of aromatic polyamide or aromatic copolyamide is a filament of linear macromolecules formed of aromatic groups held together by amide bonds, at least 85% of which are directly connected to two aromatic cores, and more particularly poly(p-phenylene terephthalamide) (or PPTA) fibres, which have been manufactured for a very long time from optically anisotropic spinning compositions. Among the aromatic polyamides or aromatic copolyamides, mention may be made of polyaryl amides (or PAA, particularly known by the Solvay company trade name Ixef), poly(metaxylylene adipamide), poly phthalamides (or PPA, particularly known by the Solvay company trade name Amodel), amorphous semi-aromatic polyamides (or PA 6-3T, particularly known by the Evonik company trade name Trogamid), meta-aramids (or poly(metaphenylene isophthalamide) or PA MPD-I, particularly known by the Du Pont de Nemours company trade name Nomex) or para-aramids (or poly(paraphenylene terephthalamide) or PA PPD-T, particularly known by the Du Pont de Nemours company trade name Kevlar or the Teijin company trade name Twaron).

A filament made of aliphatic polyamide is understood to be a filament of linear macromolecules of polymers or copolymers containing amide functions that do not have aromatic rings and can be synthesized by polycondensation between a carboxylic acid and an amine. Among the aliphatic polyamides, nylons PA4.6, PA6, PA6.6 or PA6.10, and in particular Zytel from the company DuPont, Technyl from the company Solvay or Rilsamid from the company Arkema may be mentioned.

However, since the composite cords described in the prior art result in increased mass compared to the solutions made entirely of aliphatic polyamide, they are not optimal, particularly as regards the two performance aspects essential to aircraft tires, namely endurance and mass. Furthermore, taking account of the availability of the various types of filament yarns, it is advantageous to have multiple technical solutions available, including one which minimizes the aromatic polyamide content in the cords.

One of the problems of the carcass layer hybrid cords with a low aromatic polyamide content compared with the aliphatic polyamide content is that the number of carcass layers necessary to withstand the nominal pressure is then much higher than it is for solutions which comprise a high aromatic polyamide content. For a hybrid (A330/330 N188) as described in the prior art EP1381525, the aromatic polyamide filament yarns of which have a density greater than 210 tex and an aromatic polyamide content equal to 77%, the number of carcass layers for standard sizes is from 3 to 5 carcass layers, depending on the nominal pressure. For cords of which the aromatic polyamide filament yarns have a density less than 210 tex or the aromatic polyamide content would be less than 60%, favouring the aliphatic polyamide, the number of carcass layers necessary is close to twice that, which poses problems in terms of cycle time. Favouring the aliphatic polyamide content is moreover advantageous from an environmental perspective, since manufacturing the aromatic polyamide requires the use of sulfuric acid as solvent, which is a highly toxic product the use of which must be limited in order to meet statutory obligations and safeguard the health of the workforce during the manufacturing process.

The inventors have set themselves the objective of improving said performance aspects in terms of endurance and/or mass by using hybrids of which the aromatic polyamide filament yarns have a density less than 210 tex or the aromatic polyamide content would be less than 60%, while still preserving sufficient speed of manufacture.

This improvement is obtained by an aircraft tire having a tread, a crown reinforcement and a radial carcass reinforcement,
this radial carcass reinforcement having a plurality of carcass layers having textile reinforcing elements coated with rubber compounds and oriented substantially radially, which is to say forming an angle of between 75° and 105° with the circumferential direction,
the carcass layers being anchored in each bead to at least one circumferential reinforcement or bead wire, each carcass layer having an end E in each bead, each end E being at a rubber-compound distance Epe from the closest adjacent carcass layer,
each carcass layer passing underneath the bead wire being, at its point radially on the inside of the centre of gravity of the bead wire at a distance from the axis of rotation Rt, at a rubber-compound radial distance Ept from the closest adjacent carcass layer, and having a thickness Et at its point radially on the inside of the centre of gravity of the bead wire,
the reinforcing elements of the carcass layers having a diameter d,
the reinforcing elements of the carcass reinforcement being composite cords comprising at least one aromatic polyamide filament yarn and of which the force at break is FR, measured in accordance with the standard D885/D885M-10A (2014), and these elements exhibit a deformation at least equal to 4.8% for an applied force equal to FR/4,
the tenacity of the reinforcing elements of the carcass reinforcement being at least equal to 80 daN/mm,
the ratio of the thickness Et of each carcass layer to the diameter of the reinforcing elements, measured at the point radially on the inside of the centre of gravity of the bead wire, being at least equal to 1.6 and at most equal to 2,
for each end of each carcass layer, the rubber-compound distance Epe being at least equal to 90% and at most equal to 110% of the rubber-compound radial distance Ept from the carcass layer in question to the closest adjacent layer (0.9*Ept≤Epe≤1.1*Ept),
the linear density of the one or more aromatic polyamide filament yarns of the composite cords being at most equal to 210 tex.

Specifically, optimization of the carcass layers astonishingly does not consist in looking for reinforcing elements that have good fatigue resistance and the highest possible force at break for the lowest possible mass of reinforcement. Aside from the aspects of ability to withstand the pressure referred to as the proof pressure which is equal to four times the surface pressure, research into the complex landing conditions to be observed or simulated have revealed that the deformation of the tires under these extreme conditions was virtually identical irrespective of the tenacity of the reinforcer. Under such conditions, it is beneficial to use reinforcing elements that are such that, when the tire is compressed by more than 50%, each carcass layer remains in extension, and therefore reinforcing elements that have high tenacity but also high deformation notably at the service pressure, which is one quarter of the break pressure. Experience has demonstrated that in order to optimize tire performance, the deformation of the reinforcing elements of the carcass layers at the service pressure, namely at one quarter of the force at break, needs to be at least equal to 4.6%. With this deformation under pressure, the reinforcing elements of the carcass layers do not become subjected to compression during landing. When a quarter of the break force is at least equal to 5%, preferably at least equal to 5.3%, the reinforcing elements of the carcass layers do not become subjected to compression during landings that are complicated by a crosswind which overloads one side of the carcass architecture compared to the other. Moreover, because the elastic modulus values of the reinforcers are lower in this range of stress loadings compared to the cycles experienced by the carcass layers of tires according to the prior art, the tension cycles are lower and the fatigue resistance of the carcass layers increases. Moreover, in order to obtain what is referred to as a proof pressure that is compliant with the service pressure for an acceptable mass, the reinforcing elements of the carcass layers need to have a tenacity at least equal to 80 daN/mm² and preferably at least equal to 88 daN/mm².

Movements of the filaments of the cords at the ends of the carcass layers mean that it is necessary to lay rubber compounds, referred to as edge rubbers, in order to move said ends away from the closest carcass layers, and this increases the manufacturing cycle time. The solution for preserving an acceptable speed of manufacture in spite of the number of carcass layers necessary to withstand the pressure is to not lay rubber-compound carcass layers at the end in the bead. However, to make it possible to separate the ends at the very least of the carcass lavers from the ends of the other layers, it is necessary to apply a sufficient thickness of skim layer which is at least equal to 1.6 and at most equal to 2 diameters of said cords. This is made possible by the small diameter of the cords to which the invention relates compared to the hybrids comprising aromatic polyamides and the density of which is greater than 210 tex.

This solution results in again in terms of endurance as concerns a reduction in the risks of laying deviations between the edge rubbers and the ends of the cords of the carcass layers in the bead that are observed for tires according to the prior art. In the case of a solution including the edge rubbers, it is necessary to lay twice as many products in the bead than in the case of a solution in which the skimming of the carcass layers is enough to move the ends away from adjacent carcass layers. Twice as many products involves twice as many different ways the products can be laid and therefore possible ways in which the coupling between the end of the carcass layer in question and its edge rubber can become detached. This problem is all the more pronounced if, in the bead, the relative positions of the products laid vary easily each time a transfer is made between the various manufacturing tools before the curing operation. If the decoupling is caused by the skim thickness of each carcass layer, the laying variations exist, but the relative laying variations between the ends and the edge rubbers do not. Furthermore, irrespective of the laying variation in the bead in particular, or irrespective of the movement of the products before the curing operation, with the skim thickness being constant, the end of one carcass layer is always at a minimum distance from the adjacent carcass layer. This gain is all the more pronounced if the cords have a hybrid nature; owing to the difference in stiffness, the aliphatic polyamide filament yarns are much more sensitive to wear of the filament yarns, if one or more filament yarns are made of aromatic polyamide.

One way of indicating that there is no edge rubber between the free ends of the carcass layers and the other carcass layers is to make sure that the skim thickness is constant at the end of the carcass layers and underneath the bead wire, taking account of deviations owing to the manufacture. Such a condition can be expressed as follows: for each end of each carcass layer, the rubber-compound distance Epe is at least equal to 90% and at most equal to 110% of the rubber-compound radial distance Ept from the carcass layer in question to the closest adjacent layer, measured at the point radially on the inside of the centre of gravity of the bead wire.

At the bead wire, for the radially outermost and radially innermost carcass layers, there is a single distance Ept from the edge of the cord of the carcass layer in question to the edge of the closest cord. For the other carcass layers, each carcass layer has two adjacent carcass lavers, and therefore there are two possible distances but just one minimum. These rubber-compound radial distances Ept are taken at the bead wire, at the point radially on the inside of the centre of gravity of the bead wire, which is to say where the carcass layer in question intersects the plane which is perpendicular to the axis of rotation and passes through the centre of gravity of the bead wire, the smallest of the two possible distances to the two adjacent carcass layers. The rubber-compound thicknesses are measured from the back of the cord in question to the back of the closest cord and therefore the thickness of the cable is not measured under any circumstances.

At the ends of the bead, depending on the type of laying selected and the positions of the ends, each end of the carcass layers has one or two adjacent carcass layers. For the ends where there is only one adjacent carcass layer, the measurement is trivial from the back of the cord at the end of the carcass layer in question to the back of the closest cord. For the ends where there are two adjacent carcass layers and therefore two measurable distances, the distance in question for Epe will be the smallest of the two measurable distances.

For the sake of consistency, all the measurements of rubber compound or blend thickness between two adjacent carcass layers, or of rubber-compound distance, are taken from the back of a cord of the first laver to the back of the closest cord of the adjacent layer. This is the case for the rubber-compound distance Epe at the end of each carcass layer, for the rubber-compound radial distance Ept from each carcass layer to the closest adjacent carcass layer, and for the rubber-compound radial distance Eps from each carcass layer to the adjacent carcass layer closest to the crown.

The solution of the invention makes it possible to keep the same manufacturing cycle time as a solution comprising cords in which the aromatic polyamide density is greater than 210 tex with standard skim thicknesses.

With preference, the aircraft tire according to the invention is such that the radial reinforcing elements of the carcass layers of the carcass reinforcement are composite cords of which the break force is FR, measured in accordance with the standard D885/D885M-10A (2014), and these reinforcing elements exhibit a deformation at most equal to 6.5% for an applied force equal to FR/4. Beyond such a value, the tire deforms excessively at nominal pressure. In order to limit bulk, it is therefore necessary to limit the width of the crown and therefore the volume of wearable rubber in the tire, which is not the logic of the invention.

Advantageously, the tenacity of the reinforcing elements of the carcass layers of the carcass reinforcement is at most equal to 120 daN/mm². A higher tenacity value would require a significant aromatic polyamide content, which goes against the aim of the invention, and also an excessively low aliphatic polyamide content that would not allow this aliphatic polyamide to perform its role of protecting the integrity of the cord notably in compression, which is an essential role for a reinforcer of a carcass layer.

Not laying edge rubbers at the ends in the bead makes it possible to preserve acceptable manufacturing times. For aircraft tires, it is also possible to dispose connecting rubbers between the various carcass layers underneath the crown. This is because, since the mass is such a problem in the world of aircraft tires, the carcass layers usually have a very low skim thickness, which is sufficient at the bead and the sidewalls but is such that the thickness of said skims is virtually zero underneath the crown when the tire is being shaped. Shaping is understood to mean the deformation of the carcass layers underneath the crown before the curing operation, which changes from the laying radius, which is equal to the radius of the bead wire, to a shaped radius close to the maximum radius of the carcass layer after curing. The cords come to touch one another underneath the crown, and this has an adverse effect on endurance. Therefore, it is standard to add connecting rubber layers underneath the crown. This is unnecessary with the invention. The absence of connecting rubber underneath the crown can be checked by comparing the skim thicknesses underneath the bead wire and underneath the crown while at the same time taking into account the ratios of the radii between these two points of the tire.

This requirement, which enables substantial gains in manufacturing time, is therefore that, with each carcass layer passing underneath the crown at a maximum radial distance Rm and being at a rubber-compound radial distance Eps from the closest adjacent carcass layer, for each carcass layer, the rubber-compound radial distance, or thickness, Ept to the closest adjacent carcass layer, at the point radially on the inside of the centre of gravity of the bead wire, is at least equal to 90% and at most equal to 110% of the rubber-compound radial distance Eps from the carcass layer in question to the adjacent layer closest to the crown multiplied by the ratio of the radius Rt of the carcass layer in question underneath the bead wire to the radius Rm of the carcass layer in question underneath the crown, specifically that irrespective of the carcass layer in question (0.9*Eps*(Rm/Rt)≤Ept≤1.1*Eps*(Rm/Rt)).

Advantageously, the diameter of the aircraft tire according to the invention is at most equal to 1450 mm. This is because tires of larger diameter have service conditions that are such that the invention does not afford very significant improvements.

It is advantageous if the aromatic polyamide represents less than 60% of the density of the reinforcing elements and preferably less than 50% of the density of the reinforcing elements, for environmental reasons.

As a preference, the reinforcing elements of the carcass layers are composite cords made up of one aromatic polyamide filament yarn with a linear mass of between 160 and 180 g per km, and two aliphatic polyamide filament yarns with a linear mass of between 130 and 150 g per km, with a twist of between 290 and 370 twists per metre, the reinforcing elements of the carcass reinforcement being distributed in carcass layers and disposed in said carcass layers at a pitch of between 0.6 mm and 0.9 mm.

Advantageously, the reinforcing elements of the carcass layers are composite cords made up of one aromatic polyamide filament yarn with a linear mass of between 160 and 180 g per km, and one aliphatic polyamide filament yarn with a linear mass of between 130 and 150 g per km, with a twist of between 340 and 420 twists per metre, the reinforcing elements of the carcass reinforcement being distributed in carcass layers and disposed in said carcass layers at a pitch of between 0.6 mm and 0.9 mm, preferably between 0.75 mm and 0.85 mm.

Reinforced in this way with cords made up of filament yarns having different elastic modulus values at deformations that are low and lower than those exhibited in the prior art, leading to greater deformation at the service pressure, the layers of the carcass reinforcement are surprisingly better able to withstand the working cycles.

It is known that, in the case of an aircraft tire, the composite cords used in the tire according to the invention are formed from at least two filament yarns with high elastic modulus and one single filament yarn with low elastic modulus, said cords offering the best compromise between the two properties that are the lightness of weight of the tire and the fatigue resistance of said cords. The three filament yarns above are individually overtwisted in an appropriate way and then twisted together to form the reinforcing element. However, astonishingly, experience has shown that a tire according to the invention, in which the cords of the carcass layers are made up of one filament yarn with a high elastic modulus and one or two filament yarns with a low elastic modulus, exhibits advantageous performance while still making it possible to limit the use of the filament yarn with a high modulus value.

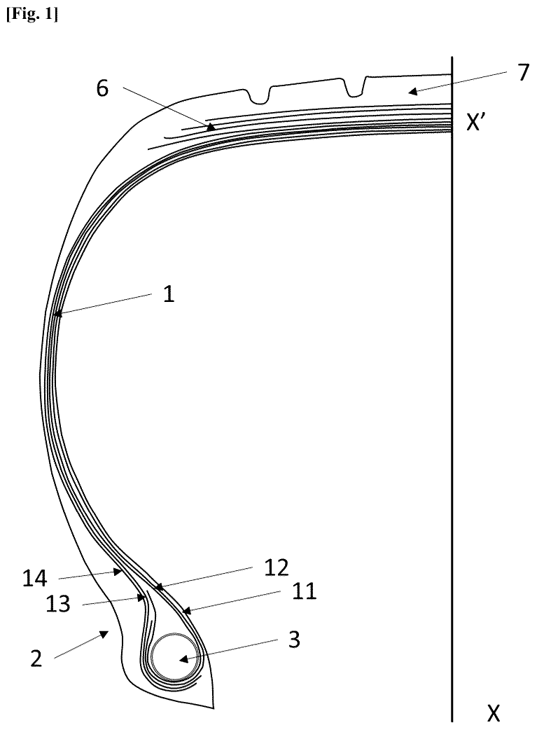

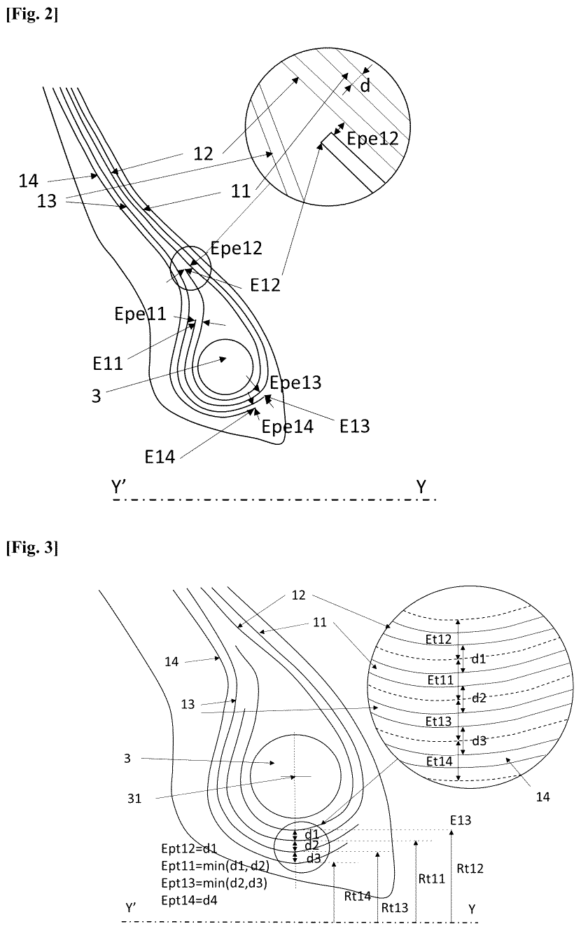

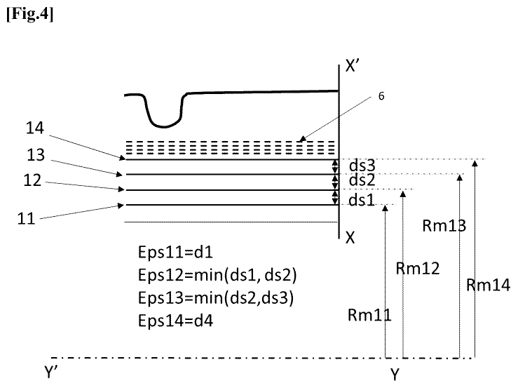

For better understanding of the invention, the features of the invention are illustrated by the schematic FIGS. 1 to 4, which are not drawn to scale. FIG. 1 shows a meridian half-section through the tire according to the invention. FIGS. 2 and 3 show one of the beads of the tire. FIG. 4 shows a part of the crown of the tire around the median circumferential plane, or equatorial plane, perpendicular to the axis of rotation of the tire passing through the centre of the tread. The invention may comprise more than 4 carcass layers. The choice of 4 carcass layers for the drawings serves solely for better understanding of the invention while not overburdening the drawings.

FIG. 1 shows a cross section through the carcass reinforcement 1 of an aircraft tire according to the invention, formed of four layers of radial textile cords (11, 12, 13, 14). In an aircraft tire, radial cords should be understood to mean cords that form angles with the circumferential direction that may be within the range 90° 15°. The four layers are wound in each bead (2) about a bead wire (3), two of them (13, 14) being wound in such a way that their ends are radially on the inside of the bead wires, and the other two (11, 12) such that their ends are radially on the outside of the bead wire, this being the case in each bead. A tread 7 and outer protective layers of the crown 6 supplement the construction of the tire under investigation, as is known.

FIG. 2 shows a cross section through one of the beads of the tire according to the invention with the bead wire (3) and the four carcass layers (11, 12, 13, 14), each having an end E (E11, E12, E13, E14, respectively) located at a distance Epe (Epe11, Epe12, Epe13, Epe14, respectively) from the closest carcass layer. A close-up of the end E12 also shows the diameter d of the cord, in the present instance of the carcass laver 11, and the measurement of the thickness of the compounds, that is to say the distance Epe12 from the edge of the cord at the end E12 to the edge of the cord of the closest carcass layer, in the present case the axially innermost strand, or main strand, of the carcass layer 12.

FIG. 3 shows a cross section through the same bead with the bead wire (3) and the four carcass layers (11, 12, 13, 14), each being at a distance Ept (Ept11, Ept12, Ept13, Ept14, respectively) from the closest adjacent carcass layer at their point radially on the inside of the centre of gravity of the bead wire (31), each being at an axial distance Rt (Rt11, Rt12, Rt13, Rt14, respectively) from the axis of rotation of the tire at said point. For the radially outermost carcass layer (14) and the radially innermost carcass layer (12) underneath the bead wire, the closest carcass layer is determined self-evidently (13 and 11, respectively) as, therefore, is the compound radial thickness d and d3, respectively. The other carcass layers all have two adjacent carcass layers; in this case, the rubber-compound distance Ept (Ept11, Ept13) to the closest adjacent carcass layer is the minimum between the two distances from the carcass layer in question to the adjacent carcass layers (Ept11=min(d1, d2), Ept13=min(d2, d3). A close-up of the carcass layers vertically beneath the centre of gravity of the bead wire also shows the measurement of the radial thicknesses d1, d2, d3 from the back of the cord of one layer to the back of the cord of the closest carcass layer, making it possible to evaluate the radial distances Ept11, Ept12, Ept13, Ept14. The close-up also shows the measurement of the thicknesses Et11, Et12, Et13, Et14 of each carcass layer at the point radially on the inside of the centre of gravity of the bead wire, each dotted curve showing the boundary between two carcass layers.

FIG. 4 shows a cross section through the crown of the aircraft tire close to the equatorial plane of the crown layers 6 and the four carcass layers (11, 12, 13, 14). In an axial section through a plane comprising the axis of the tire, each of the four carcass layers (11, 12, 13, 14) intersects the equatorial plane at a radius point Rm (Rm11, Rm12, Rm13, Rm14, respectively). The rubber-compound distance from each carcass layer to the closest carcass layer is denoted Eps (Eps11, Eps12, Eps13, Eps14). For the carcass layer (14) radially furthest on the outside and the carcass layer (11) radially furthest on the inside of the crown, the closest carcass layer is determined, self-evidently, as 13 and 12, respectively as, therefore, is the compound radial thickness (d1 and d3, respectively). The other carcass layers all have two adjacent carcass layers; in this case, the rubber-compound distance Eps (Eps12, Eps13) to the closest adjacent carcass layer is the minimum between the two distances from the carcass layer in question to the adjacent carcass layers (Eps12=min(d1, d2); Eps13=min(d2, d3).

The measurements are taken either by non-destructive methods (tomography, etc.) on a tire mounted on a standard rim at a pressure of 1 bar, or on an axial section of the tire of which the beads are placed at an identical angle to the standard rim and at the same spacing, this being a known practice for those skilled in the art. The radii (Rm, Rt) of the carcass layers underneath the bead wire or underneath the crown are measured at the middle fibre of each carcass laver. To measure the distances Et between the carcass layers underneath the bead wire if it is not possible to distinguish between the various skim compounds from one layer to the next, it will be considered that each carcass layer comprises half the thickness of the skim compound between the two cords of the two carcass layers in question.

The invention was tested on a tire of the standard size 52X21R22 38PR. It was compared with two control tires:
tire T1 of which the carcass layers are made up of aliphatic polyamide cords.
a tire T2 of which the carcass layers comprise hybrid cords.

For the control tire T1, according to the prior art, the six carcass reinforcement layers of the aircraft tire in question are formed by three aliphatic polyamide (more specifically nylon) filament yarns having a count equal to 280 tex, said filament yarn being individually overtwisted with an S-twist of 215 twists/metre. The three filament yarns that are already twisted on themselves are then twisted together with a Z-twist of 215 twists/metre to form the cord ready for use in layers. In this instance, the cord used has a tenacity substantially equal to 62.4 daN/mm² and a deformation of around 17.3%11% at FR/4. The reinforcers are disposed at a pitch of 1.33 mm. The aromatic polyamide content of the carcass layers is thus 0%. The diameter of the cords of the control tire is 1.19 mm. The thickness Et of each carcass layer at the point radially on the inside of the centre of gravity of the bead wire is equal to 1.67 mm. The ratio of the thickness Et of the carcass layers and the diameter of the reinforcing elements is thus equal to 1.4. In the bead, the ends of the carcass layers are moved away from the closest carcass layer by virtue of rubbers referred to as decoupling rubbers that have a thickness of 0.8 mm and are inserted between said ends and the corresponding adjacent carcass layers. This step is necessary for the endurance of the bead and increases the manufacturing time. (On average, Epe=2.5*Ept). At the crown, to allow a minimum distance between the carcass layers, a decoupling rubber is disposed between the carcass layers over at least the width of the crown, having a radial thickness equal to 0.8 mm.

For the control tire T2, according to the prior art, the four carcass reinforcing layers of the aircraft tire in question are formed of composite cords made up of two aromatic polyamide filament yarns, each filament yarn having a count of 330 tex, individually overtwisted with an S-twist of 270 twists/metre, and one aliphatic polyamide (more specifically nylon) filament yarn having a count equal to 188 tex, said filament yarn being individually overtwisted with an S-twist of 270 twists/metre. The three filament yarns that are already twisted on themselves are then twisted together with a Z-twist of 270 twists/metre to form the cord ready for use in layers. In this instance, the cord used has a tenacity substantially equal to 128 daN/mm² and a deformation of around 4.2% at FR/4. The reinforcers are disposed at a pitch of 1.2 mm. The aromatic polyamide content of the carcass layers is thus 78%. The diameter of the cords of the control tire is 1.1 mm; the thickness Et of each carcass layer at the point radially on the inside of the centre of gravity of the bead wire is equal to 1.6 mm. The ratio of the thickness Et of the carcass layers and the diameter of the reinforcing elements is thus equal to 1.45. In the bead, the ends of the carcass layers are moved away from the closest carcass layer by virtue of rubbers referred to as decoupling rubbers that have a thickness of 0.8 mm and are inserted between said ends and the corresponding adjacent carcass layers. This step is necessary for the endurance of the bead and increases the manufacturing time. (On average, Epe=2.5*Ept). At the crown, to allow a minimum distance between the carcass layers, a decoupling rubber is disposed between the carcass layers over at least the width of the crown, having a radial thickness equal to 0.8 mm.

The invention was tested with composite cords made up of one aromatic polyamide filament yarn, having a count of 167 tex, overtwisted with an S-twist of 380 twists/metre, and one aliphatic polyamide (more specifically nylon) filament yarn having a count equal to 140 tex, said filament yarn being overtwisted with an S-twist of 380 twists/metre. The two filament yarns that are already twisted on themselves are then twisted together with a Z-twist of 380 twists/metre to form the cord ready for use in layers. In this instance, the cord used has a tenacity substantially equal to 96 daN/mm² and a deformation of around 5% at FR/4, and has a diameter of 0.66 mm. The reinforcers are disposed at a pitch of 0.79 mm. The aromatic polyamide content of the carcass layer is equal to 54%.

The tire according to the invention comprises 8 carcass layers of thickness 1.33 mm measured at the point radially on the inside of the centre of gravity of the bead wire. The ratio of the thickness Et of the carcass layers to the diameter of the reinforcing elements is thus equal to 1.68. No decoupling rubber is placed in the bead at the ends of the carcass layers, since the thickness of the skim rubbers, 0.45 mm in each case, is sufficient to decouple the ends from the carcass of the adjacent carcass layers. No decoupling rubber is disposed at the crown. As a result, the manufacturing time is substantially identical to the control tire because decoupling rubbers are not laid in the bead and in the crown, in spite of the increase in the number of carcass layers. The rubber-compound thicknesses between the cords of the carcass layers adjusted for the radius differences remain constant between the crown and the bead while at the same time taking into account the manufacturing tolerances (0.9*Eps*(Rm/Rt)≤Ept≤1.1*Eps*(Rm/Rt)).

In the instances presented, for each tire, all the carcass layers use the same cord at the same pitch and the same rubber-compound thicknesses, although this is not a requisite of the invention, it being possible for the density to differ as required depending on the layers.

In the control tire and the tire according to the invention, the rubber compounds that coat the composite cords of the carcass layers are identical. The same is true of the crown layers and the tread.

According to our numerical simulations, a tire according to the invention as described above was tested, with successful outcome, in accordance with the standard TSO C62e which notably tests tire endurance. Compared to the control tire T1 of the same size, the weight of the tire 1 according to the invention is lightened by 5.5 kg, and makes it possible to increase the number of landings by 5%, thereby demonstrating the benefit of these cords in reducing the mass of the tire casings or increasing the number of landings to which the carcass can be subjected.

According to our numerical simulations, and notably the compression rate values for the carcass layers, compared with the control tire T2 of the same size, the endurance of the tire according to the invention would be 10% as concerns the degradation of the break force after a rolling road test corresponding to taxiing.

1. An aircraft tire having a tread, a crown reinforcement and a radial carcass reinforcement,
the radial carcass reinforcement having a plurality of carcass layers having textile reinforcing elements coated with rubber compounds and oriented substantially radially forming an angle of between 75° and 105° with the circumferential direction,
the carcass layers being anchored in each bead to at least one circumferential reinforcement or bead wire, each carcass layer having an end E (E11, E12, E13, E14) in each bead, each end E (E11, E12, E13, E14) being at a rubber-compound distance Epe (Epe11, Epe12, Epe13, Epe14) from the closest adjacent carcass layer,
each carcass layer passing underneath the bead wire being, at its point radially on the inside of the centre of gravity of the bead wire at a distance from the axis of rotation Rt (Rt11, Rt12, Rt13, Rt14), at a rubber-compound radial distance Ept (Ept11, Ept12, Ept13, Ept14) from the closest adjacent carcass layer, and having a thickness Et (Et11, Et12, Et13, Et14) at its point radially on the inside of the centre of gravity (31) of the bead wire,
the reinforcing elements of the carcass layers having a diameter d,
wherein the reinforcing elements of the carcass reinforcement are composite cords comprising at least one aromatic polyamide filament yarn and of which the force at break is FR, measured in accordance with the standard D885/D885M-10A (2014), and these elements exhibit a deformation at least equal to 4.8% for an applied force equal to FR/4,
wherein the tenacity of the reinforcing elements of the carcass reinforcement is at least equal to 80 daN/mm²,
wherein the ratio of the thickness Et (Et11, Et12, Et13, Et14) of each carcass layer to the diameter of the reinforcing elements, measured at the point radially on the inside of the centre of gravity of the bead wire, is at least equal to 1.6 and at most equal to 2,
wherein, for each end of each carcass layer, the rubber-compound distance Epe (Epe11, Epe12, Epe13, Epe14) is at least equal to 90% and at most equal to 110% of the rubber-compound radial distance Ept (Ept11, Ept12, Ept13, Ept14) from the carcass layer in question to the closest adjacent layer (0.9*Ept≤Epe≤1.1*Ept), and wherein the linear density of the one or more aromatic polyamide filament yarns of the composite cords is at most equal to 210 tex.

2. The aircraft tire according to claim 1, wherein the radial reinforcing elements of the carcass reinforcement exhibit a deformation at least equal to 5.3% for an applied force equal to FR/4.

3. The aircraft tire according to claim 1, wherein the radial reinforcing elements of the carcass reinforcement are composite cords of which the force at break is FR, measured in accordance with the standard D885/D885M-10A (2014), and these elements exhibit a deformation at most equal to 6.5% for an applied force equal to FR/4.

4. The aircraft tire according to claim 1, wherein the tenacity of the reinforcing elements of the carcass reinforcement is at most equal to 120 daN/mm².

5. The aircraft tire according to claim 1, with each carcass layer passing underneath the crown at a maximum radial distance Rm (Rm11, Rm12, Rm13, Rm14) and being at a rubber-compound radial distance Eps (Eps11, Eps12, Eps13, Eps14) from the closest adjacent carcass layer, wherein, for each carcass layer at the point radially on the inside of the centre of gravity of the bead wire, the rubber-compound radial distance Ept (Ept11, Ept12, Ept13, Ept14) to the closest adjacent carcass layer is at least equal to 90% and at most equal to 110% of the rubber-compound radial distance Eps (Eps11, Eps12, Eps13, Eps14) from the carcass layer in question to the adjacent layer closest to the crown multiplied by the ratio of the radii Rt (Rt11, Rt12, Rt13, Rt14) to Rm (Rm11, Rm12, Rm13, Rm14) (irrespective of the carcass layer in question 0.9*Eps*(RmIRt)≤Ept≤1.1*Eps*(Rm/Rt)).

6. The aircraft tire according to claim 1, wherein the diameter is at most equal to 1450 mm.

7. The aircraft tire according to claim 1 wherein the aromatic polyamide represents less than 60% of the density of the reinforcing elements and preferably less than 50% of the density of the reinforcing elements.

8. The aircraft tire according to claim 1 wherein the reinforcing elements of the carcass reinforcement are composite cords made up of an aromatic polyamide filament yarn with a linear mass of between 160 and 180 g per km, and two aliphatic polyamide filament yarns with a linear mass of between 130 and 150 g per km, with twists of between 290 and 370 twists per metre, the reinforcing elements of the carcass reinforcement being distributed in carcass layers and disposed in said carcass layers at a pitch of between 0.6 mm and 0.9 mm.

9. The aircraft tire according to claim 1, wherein the reinforcing elements of the carcass reinforcement are composite cords made up of one aromatic polyamide filament yarn with a linear mass of between 160 and 180 g per km, and one aliphatic polyamide filament yarn with a linear mass of between 130 and 150 g per km, with twists of between 340 and 420 twists per metre, the reinforcing elements of the carcass reinforcement being distributed in carcass layers and disposed in said carcass layers at a pitch of between 0.6 mm and 0.9 mm, preferably between 0.75 mm and 0.85 mm.
